(19) United States
(12) Patent Application Publication
(10) Pub. No.: US 2024/0332631 A1
(43) Pub. Date: Oct. 3, 2024

(54) METHOD FOR MANUFACTURING NON-AQUEOUS SECONDARY BATTERY AND DEVICE FOR MANUFACTURING NON-AQUEOUS SECONDARY BATTERY

(71) Applicant: HONDA MOTOR CO., LTD., Tokyo (JP)

(72) Inventors: Kosei MIYATA, Saitama (JP); Kenta UMETSU, Saitama (JP); Takashi TOYOSHIMA, Saitama (JP); Hiroki ICHIHARA, Saitama (JP); Makoto HACHIYA, Kanagawa (JP)

(21) Appl. No.: 18/586,559

(22) Filed: Feb. 26, 2024

(30) Foreign Application Priority Data
Mar. 28, 2023 (JP) 2023-051142

(51) Int. Cl. H01M 10/0585; H01M 10/0562

(52) U.S. Cl. CPC H01M 10/0585; H01M 10/0562; H01M 2300/0065

(57) ABSTRACT

Provided is a non-aqueous secondary battery manufacturing method capable of reducing deformation of a laminated body. A method for manufacturing a non-aqueous secondary battery includes, in this order, a lamination step of laminating a positive electrode layer containing a positive electrode active material and an electrolyte layer containing a solid electrolyte to obtain a laminated body, a recess-protrusion formation step of forming a recess and/or a protrusion extending from one side to the other side in the planar direction of the laminated body while applying pressure to the laminated body in the thickness direction thereof from the one side to the other side, and a pressurization flattening step of flattening the recess and/or the protrusion while applying pressure to the laminated body in the thickness direction thereof.

This application is based on and claims the benefit of priority from Japanese Patent Application No. 2023-051142, filed on 28 Mar. 2023, the content of which is incorporated herein by reference.

### BACKGROUND OF THE INVENTION

### Field of the Invention

The present invention relates to a method for manufacturing a non-aqueous secondary battery and a device for manufacturing a non-aqueous secondary battery.

### Related Art

In recent years, in order to ensure more people have access to reasonable, reliable, sustainable, and advanced energy, research and development have been conducted on a secondary battery contributing to enhancement of energy efficiency.

As such a secondary battery, there has been known a non-aqueous secondary battery, such as a lithium ion secondary battery, configured such that an electrolyte layer is arranged between a positive electrode layer and a negative electrode layer. The above-described non-aqueous secondary battery is pressurized by a method such as roll press in a manufacturing process for the purpose of, e.g., density improvement.

For example, as a positive electrode plate manufacturing method in which the packing density of the positive electrode active material compounding agent is uniformly enhanced while the occurrence of a defective shape of a positive electrode plate precursor and falling off of a positive electrode active material compounding agent is reduced upon rolling, a method in which the positive electrode plate precursor is rolled with an embossing roll pair including a pair of embossing rolls has been disclosed (see, e.g., Japanese Unexamined Patent Application, Publication No. H9-204915).
Patent Document 1: Japanese Unexamined Patent Application, Publication No. H9-204915

### SUMMARY OF THE INVENTION

The technique disclosed in Japanese Unexamined Patent Application, Publication No. H9-204915 is for reducing the occurrence of the defective shape of the positive electrode plate precursor and falling off of the positive electrode active material compounding agent upon rolling by rolling the positive electrode plate precursor with the embossing rolls in two stages. However, in a case where the above-described method is applied to an electrode laminated body, the electrode laminated body cannot be obtained with a uniform thickness. In addition, deformation of the laminated body in the width direction thereof upon rolling cannot be sufficiently reduced.

The present invention has been made in view of the above-described points, and an object thereof is to provide a non-aqueous secondary battery manufacturing method capable of reducing deformation of a laminated body.
(1) The present invention relates to a method for manufacturing a non-aqueous secondary battery, which includes, in this order, a lamination step of laminating a positive electrode layer containing a positive electrode active material and an electrolyte layer containing a solid electrolyte to obtain a laminated body, a recess-protrusion formation step of forming a recess and/or a protrusion extending from one side to the other side in the planar direction of the laminated body while applying pressure to the laminated body in the thickness direction thereof from the one side to the other side, and a pressurization flattening step of flattening the recess and/or the protrusion while applying pressure to the laminated body in the thickness direction thereof.

According to the aspect (1) of the present invention, the non-aqueous secondary battery manufacturing method capable of reducing the deformation of the laminated body can be provided.
(2) The method for manufacturing the non-aqueous secondary battery according to (1), in which in the recess-protrusion formation step, a pressurization member having a projecting portion projecting from a base portion is pressurized in contact with the laminated body to form the recess and/or the protrusion in the laminated body, and upon pressurization, only the projecting portion of the pressurization member contacts the laminated body.

According to the aspect (2) of the present invention, the area of contact between the pressurization member and the laminated body can be reduced, and stress can be locally increased. Thus, a density at a location where the projecting portion contacts the laminated body can be easily increased.
(3) The method for manufacturing the non-aqueous secondary battery according (1) or (2), which further includes, before the recess-protrusion formation step, a warming step of warming the laminated body.

According to the aspect (3) of the present invention, unevenness in the temperature of the laminated body can be reduced in the recess-protrusion formation step, and therefore, the homogeneity of the laminated body can be enhanced by pressurization.
(4) The method for manufacturing the non-aqueous secondary battery according to any one of (1) to (3), in which the recess-protrusion formation step and the pressurization flattening step are performed in such a manner that the laminated body passes between rollers, and the diameter of each roller used in the pressurization flattening step is greater than the diameter of each roller used in the recess-protrusion formation step.

According to the aspect (4) of the present invention, the recess and/or the protrusion can be easily and precisely formed in the recess-protrusion formation step, and therefore, the accuracy of the recess and/or the protrusion can be enhanced. The curvature of the roller is set so that the laminated body can be homogeneously pressurized and flattened in the pressurization flattening step, and therefore, deformation of the laminated body due to undulation can be further reduced.
(5) The present invention relates to a device for manufacturing a non-aqueous secondary battery, which includes a laminator that laminates a positive electrode layer containing a positive electrode active material and an electrolyte layer containing a solid electrolyte to obtain a laminated body, a recess-protrusion former that forms a recess and/or a protrusion extending from one side to the other side in the planar direction of the laminated body while applying pressure to the laminated body in the thickness direction thereof from the one side to the other side, and a pressurization flattener that flattens the recess and/or the protrusion while applying pressure to the laminated body in the thickness direction thereof.

According to the aspect (5) of the present invention, the manufacturing method of (1) can be performed.
(6) The device for manufacturing the non-aqueous secondary battery according to (5), in which each of the recess-protrusion former and the pressurization flattener has rollers that sandwich the laminated body while the laminated body passes therebetween, and the diameter of each roller of the pressurization flattener is greater than the diameter of each roller of the recess-protrusion former.

According to the aspect (6) of the present invention, the manufacturing method of (4) can be performed.

### BRIEF DESCRIPTION OF THE DRAWINGS

FIG. 1 is a view showing the configuration of a non-aqueous secondary battery manufacturing device according to one embodiment of the present invention;

FIG. 2 is a view showing a recess-protrusion former according to one embodiment of the present invention;

FIG. 3 is a view showing the configuration of a laminated body according to one embodiment of the present invention; and

FIG. 4 is a view showing simulation results when a recess and a protrusion are formed in the laminated body by a non-aqueous secondary battery manufacturing method of the present invention.

### DETAILED DESCRIPTION OF THE INVENTION

### [Non-Aqueous Secondary Battery]

A non-aqueous secondary battery manufactured by a non-aqueous secondary battery manufacturing method according to the present embodiment includes, for example, a semi-solid-state lithium ion battery having an electrolyte in a gel state and an all-solid-state lithium ion battery having an electrolyte in a solid state.

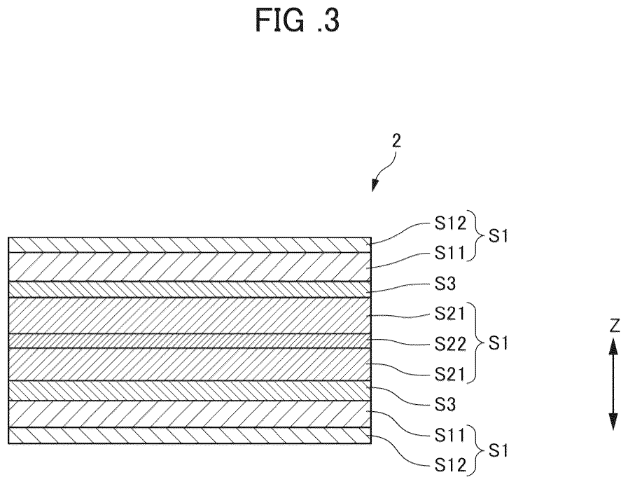

The non-aqueous secondary battery according to the present embodiment has a laminated body S configured such that electrode layers and an electrolyte layer arranged therebetween are laminated on each other. For example, as shown in FIG. 3, the laminated body S has a negative electrode layer S1, a positive electrode layer S2, and an electrolyte layer S3 arranged therebetween. Note that FIG. 3 shows, as an example, the configuration of a laminated body of a finally-manufactured non-aqueous secondary battery. A laminated body which is a target in which a recess and/or a protrusion are formed by a recess-protrusion formation step which is one step of the non-aqueous secondary battery manufacturing method according to the present embodiment will be described later.

### (Positive Electrode Layer)

The positive electrode layer S2 has positive electrode active material layers S21 and a positive electrode current collector S22. In the present embodiment, the positive electrode active material layers S21 are laminated on both surfaces of the positive electrode current collector S22. Note that the configuration of the positive electrode layer S2 is not limited to above and the positive electrode active material layer may be laminated on one surface of the positive electrode current collector.

The positive electrode active material layer S21 is a layer essentially containing a positive electrode active material. The positive electrode active material is not particularly limited, and a substance well-known as a positive electrode active material of a non-aqueous secondary battery may be used. The positive electrode active material to be used may include, for example, ternary positive electrode materials such as LiCoO₂, LiNiO₂, and NCM(Li(NiₓCo_{y}Mn_{z})O₂ (0<x<1, 0<y<1, 0<z<1, x+y+z=1)), layered positive electrode active material particles of LiVO₂, LiCro₂, etc., spinel-type positive electrode active materials such as LiMn₂O₄, Li (Ni_{0.25}Mn_{0.75})₂O₄, LiCoMnO₄, and Li₂NiMn₃O₈, and olivine-type positive electrode active materials such as LiCoPO₄, LiMnPO₄, and LiFePO₄.

The positive electrode active material layer S21 may further contain a solid electrolyte, a conductive assistant, a binder, etc. in addition to the positive electrode active material. The solid electrolyte, the conductive assistant, the binder, etc. are not particularly limited, and substances well-known as electrode materials of a non-aqueous secondary battery may be applied.

The positive electrode current collector S22 is not particularly limited, and a substance well-known as a positive electrode current collector of a non-aqueous secondary battery may be used. The positive electrode current collector S22 may include, for example, metal foils such as stainless steel (SUS) foil and aluminum (Al) foil.

### (Electrolyte Layer)

The electrolyte layer S3 is a layer arranged between the negative electrode layer S1 and the positive electrode layer S2 and essentially containing a solid electrolyte. The electrolyte layer may contain a binder, etc. in addition to the substance described above.

The solid electrolyte is not particularly limited, and may include, for example, sulfide-based solid electrolytes, oxide-based solid electrolytes, nitride-based solid electrolytes, and halide-based solid electrolytes.

### (Negative Electrode Layer)

The negative electrode layer S1 has a negative electrode active material layer S11 and a negative electrode current collector S12. In the present embodiment, the negative electrode active material layer S11 is laminated in contact with the electrolyte layer S3.

The negative electrode active material layer S11 is a layer essentially containing a negative electrode active material. The negative electrode active material is not particularly limited, and a substance well-known as a negative electrode active material of a non-aqueous secondary battery may be used. The negative electrode active material may include, for example, lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, silicon-based materials such as elemental silicon, silicon alloy, and a silicon compound, lithium metal, lithium alloy, and metal indium.

The negative electrode active material layer S11 may further contain a solid electrolyte, a conductive assistant, a binder, etc. in addition to the negative electrode active material. The solid electrolyte, the conductive assistant, the binder, etc. are not particularly limited, and substances well-known as electrode materials of a non-aqueous secondary battery may be applied.

The negative electrode current collector S12 is not particularly limited, and a substance well-known as a negative electrode current collector of a non-aqueous secondary battery may be used. The negative electrode current collector may include, for example, metal foils such as copper (Cu) foil, stainless steel (SUS) foil, and aluminum (Al) foil.

### <Method for Manufacturing Non-Aqueous Secondary Battery>

The method for manufacturing the non-aqueous secondary battery includes, in this order, a lamination step of obtaining a laminated body configured such that at least a positive electrode layer and an electrolyte layer are laminated on each other, a recess-protrusion formation step of forming a recess and/or a protrusion in the obtained laminated body, and a pressurization flattening step of flattening the recess and/or the protrusion. Note that the above-described steps are at least some of the steps in the non-aqueous secondary battery manufacturing method and the non-aqueous secondary battery manufacturing method according to the present embodiment may include a step other than those described above. For example, the method may include a warming step of warming the entire laminated body obtained by the lamination step between the lamination step and the recess-protrusion formation step.

The lamination step is a step of laminating at least the positive electrode layer and the electrolyte layer on each other. The lamination step may be a step of laminating the sheet-shaped positive electrode layer and electrolyte layer molded independently of each other. The lamination step may be, instead of that described above, a step of applying an electrolyte layer slurry containing a material forming the electrolyte layer to the positive electrode layer and drying the electrolyte layer slurry or a step of applying a positive electrode layer slurry containing a material forming the positive electrode layer to the electrolyte layer and drying the positive electrode layer slurry. The above-described application and drying method is not particularly limited, and a method well-known as a method for manufacturing a non-aqueous secondary battery may be applied. Instead of the above-described step, the lamination step may be a step of laminating the positive electrode layer, the electrolyte layer, and a negative electrode layer on each other.

The warming step is a step of warming the entire laminated body obtained by the lamination step. Unevenness in the temperature of the laminated body can be reduced by the warming step, and therefore, the homogeneity of the laminated body can be enhanced in the recess-protrusion formation step. A method for warming the laminated body in the warming step is not particularly limited, and a method using a well-known heating device such as a ceramic heater, a sheathed heater, a halogen lamp heater, or an induction heater may be applied.

The recess-protrusion formation step is a step of forming the recess and/or the protrusion in the laminated body obtained by the lamination step. In the recess-protrusion formation step, the recess and/or the protrusion are formed in the laminated body while pressure is applied in the thickness direction of the laminated body from one side toward or to the other side in the planar direction of the laminated body. As a result, the recess and/or the protrusion extending from the one side toward or to the other side of the laminated body are formed. That is, a direction of applying the pressure to the laminated body in the recess-protrusion formation step and a direction in which the formed recess and/or protrusion extend are the same direction. When the laminated body is pressurized to have a higher density, in a case where the laminated body is merely uniformly pressurized in the thickness direction without the recess-protrusion formation step, displacement (undulation) of the laminated body in the width direction thereof is caused, and due to such displacement, warpage of the laminated body may be caused. The recess-protrusion formation step and the pressurization flattening step are performed in this order so that the displacement of the laminated body in the width direction thereof can be reduced.

The shapes of the recess and/or the protrusion formed by the recess-protrusion formation step are not particularly limited, and for example, may include a form in which a protrusion is formed between recesses formed in a groove or dot shape. In the above-described case, the shape of the recess may include, for example, a quadrangular shape, a wedge shape, a semi-circular shape, and a combination thereof as viewed in section, but is not particularly limited thereto. The recess and/or the protrusion is preferably uniformly formed in the width direction of the laminated body.

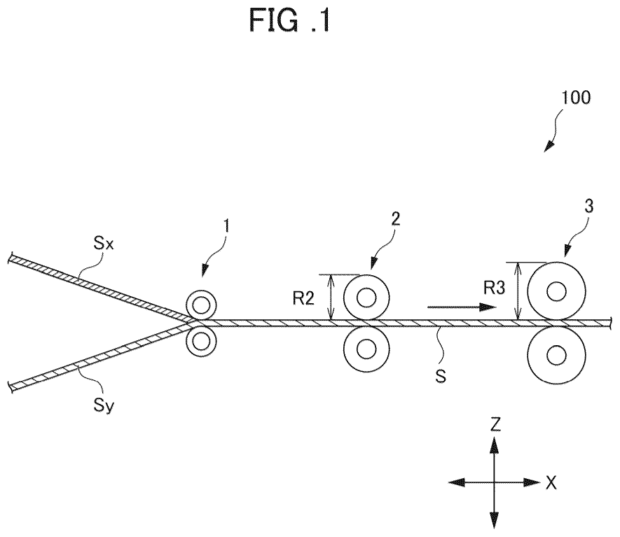

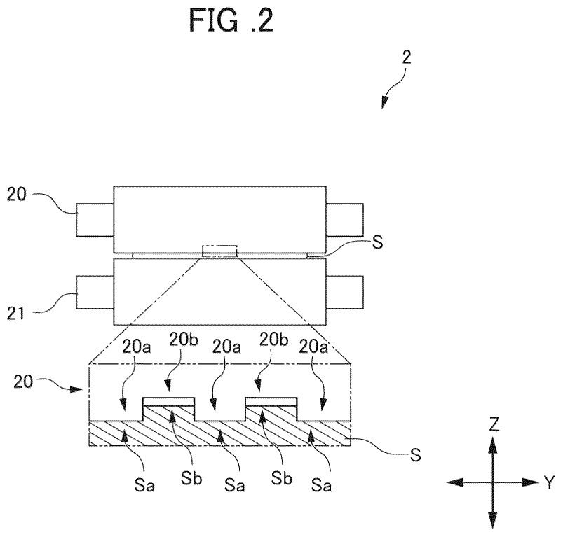

For example, as shown in FIGS. 1 and 2, the recess-protrusion formation step is performed in such a manner that the laminated body passes between a pair of rollers 20, 21 as a pressurization member in a roll press device 2 having the rollers 20, 21. Note that in FIGS. 1 and 2, the thickness direction of the above-described laminated body is indicated by a Z-direction. The direction of applying the pressure to the laminated body in the recess-protrusion formation step, i.e., the direction from the one side to the other side in the planar direction of the laminated body, is indicated by an X-direction. The width direction of the laminated body is indicated by a Y-direction. The pressurization member is not limited to the pair of rollers, and for example, may be one roller. A configuration in which the pressurization member is the pair of rollers 20, 21 will be described below.

The roller 20 as the pressurization member has a projecting portion 20a projecting from a base portion in the Z-direction, as shown in FIG. 2. The projecting portion 20a is formed along the circumferential direction of the roller 20. A plurality of projecting portions 20a may be formed in the Y-direction. In a case where the plurality of projecting portions 20a is formed, a depressed portion 20b is formed between adjacent ones of the projecting portions 20a. The projecting portion 20a of the roller 20 contacts the laminated body S and the roller 20 is pressurized in the Z-direction, and in this manner, a recess Sa is formed in the laminated body S. In a case where the plurality of projecting portions 20a is formed, a protrusion Sb is formed between adjacent ones of the recesses Sa in the laminated body S.

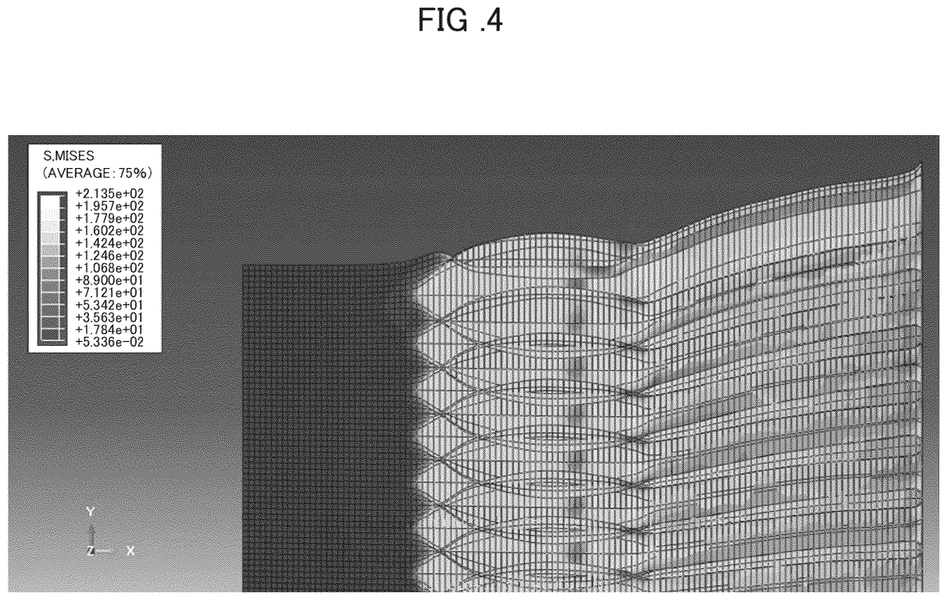

FIG. 4 shows simulation results of stress distribution when the laminated body S is pressurized by the roller as the pressurization member having the projecting portion. Simulation was conducted by a finite element method. FIG. 4 clearly shows that a portion where the stress is low extends in the X-direction and the recess and/or the protrusion extending from the one side to the other side are formed in the laminated body S.

FIG. 2 shows the configuration in which the projecting portion 20a is formed in the roller 20 arranged above the laminated body S, but a similar projecting portion is also preferably formed in the roller 21 arranged below the laminated body S. That is, in the recess-protrusion formation step, the recess and/or the protrusion are preferably formed in both surfaces of the laminated body S. The recess and/or the protrusion are formed in both surfaces of the laminated body S so that the deformation of the laminated body S such as warpage can be further reduced.

When the roller 20 is pressurized in contact with the laminated body S, only the projecting portion 20a preferably contacts the laminated body S as shown in FIG. 2. That is, preferably, the bottom of the depressed portion 20b does not contact the laminated body S. With this configuration, the area of contact between the roller 20 and the laminated body S is reduced, and the stress is concentrated on the projecting portion 20a. Thus, the density of the laminated body S in the recess Sa can be further increased. In a case where the projecting portion similar to that of the roller 20 is also formed in the roller 21, the positions of the projecting portions of the roller 21 and the roller 20 in the X-direction and the Y-direction are preferably coincident with each other upon pressurization of the laminated body S. With this configuration, the density of the laminated body S in the recess can be much further increased.

The pressurization flattening step is a step of pressurizing the laminated body S such that the recess and/or the protrusion of the laminated body S formed by the recess-protrusion formation step are flattened and the thickness of the laminated body S becomes uniform. The laminated body S is uniformly pressurized to have a higher density by the pressurization flattening step. In the pressurization flattening step, the stress is concentrated on a thick portion of the laminated body S, and the laminated body S is flattened. In this step, when the thick portion (e.g., protrusion Sb in FIG. 2) of the laminated body S is crushed, the crushed portion can enter a thin portion (e.g., recess Sa in FIG. 2) of the laminated body S. Thus, elongation of the laminated body S in the Y-direction is reduced as compared to a case of not performing the recess-protrusion formation step, and the undulation of the laminated body S is reduced.

For example, as shown in FIG. 1, the pressurization flattening step is performed in such a manner that the laminated body passes between a pair of rollers in a roll press device 3 having the rollers. The surface of the roller contacting the laminated body in the roll press device 3 is a flat surface, and is formed with no projecting portion. A specific method in the pressurization flattening step is not limited to the method using the pair of rollers, and for example, may be a method using one roller or a method by flat press.

In a case where the pressurization flattening step is performed by the roll press device 3 shown in FIG. 1, the diameter R3 of the roller of the roll press device 3 is preferably greater than the diameter R2 of the roller of the roll press device 2 for performing the recess-protrusion formation step. With this configuration, the curvature of the roller of the roll press device 3 is smaller so that the laminated body S can be more uniformly pressurized and the deformation of the laminated body S due to the undulation can be further reduced. Note that the diameter R2 of the roller of the roll press device 2 is smaller than the diameter R3 of the roller of the roll press device 3 so that the recess and/or the protrusion can be precisely and easily formed in the laminated body S.

The laminated body formed with the recess and/or the protrusion by the recess-protrusion formation step and subsequently flattened by the pressurization flattening step may be the laminated body configured such that at least the positive electrode layer and the electrolyte layer are laminated on each other. The above-described laminated body may be the laminated body configured such that the positive electrode layer, the electrolyte layer, and the negative electrode layer are laminated on each other as shown in FIG. 3.

### <Device for Manufacturing Non-Aqueous Secondary Battery>

A non-aqueous secondary battery manufacturing device 100 that performs the above-described non-aqueous secondary battery manufacturing method has, as shown in FIG. 1, a laminator 1, the roll press device 2 as a recess-protrusion former, and the roll press device 3 as a pressurization flattener. FIG. 1 shows, as an example, part of a roll-to-roll device that laminates a sheet body Sx and a sheet body Sy on each other and pressurizes these bodies by roll press. The above-described device is one example, and the device 100 may be a device that laminates and pressurizes sheet bodies delivered by a delivery device such as a belt conveyer.

For example, as shown in FIG. 1, the laminator 1 laminates, by lamination rolls, the sheet body Sx including a positive electrode layer formed in a sheet shape on the sheet body Sy including an electrolyte layer formed in a sheet shape. The configuration of the laminator 1 is not limited to above, and, e.g., an application device that applies a positive electrode layer slurry or an electrolyte layer slurry to the sheet body Sx or the sheet body Sy formed in advance or a combination of the laminator 1 and the application device may be used.

The configuration of the roll press device 2 as the recess-protrusion former is as in description of the recess-protrusion formation step above, and the roll press device 2 has, for example, the pair of rollers provided one above the other in the thickness direction of the laminated body. At least one of the rollers is formed with the projecting portion. The recess and/or the protrusion are formed in the laminated body in such a manner that the laminated body passes between the pair of rollers. The configuration of the recess-protrusion former is not limited to above, and for example, may be a device including one roller.

The configuration of the roll press device 3 as the pressurization flattener is as in description of the pressurization flattening step above, and the roll press device 3 has, for example, the pair of rollers provided one above the other in the thickness direction of the laminated body. The surfaces of the pair of rollers contacting the laminated body are the flat surfaces, and are formed with no projecting portions. The configuration of the pressurization flattener is not limited to above, and for example, may be a device including one roller or a flat press device.

The preferred embodiment of the present invention has been described above, but the present invention is not limited to the above-described embodiment and changes and modifications made within a scope in which the object of the present invention can be achieved are included in the present invention.

### EXPLANATION OF REFERENCE NUMERALS

100 Non-Aqueous Secondary Battery Manufacturing Device
1 Laminator
2 Recess-Protrusion Former
3 Pressurization Flattener
S Laminated Body

What is claimed is:

1. A method for manufacturing a non-aqueous secondary battery, comprising: in this order,
a lamination step of laminating a positive electrode layer containing a positive electrode active material and an electrolyte layer containing a solid electrolyte to obtain a laminated body;
a recess-protrusion formation step of forming a recess and/or a protrusion extending from one side to the other side in a planar direction of the laminated body while applying pressure to the laminated body in a thickness direction thereof from the one side to the other side; and
a pressurization flattening step of flattening the recess and/or the protrusion while applying pressure to the laminated body in the thickness direction thereof.

2. The method for manufacturing the non-aqueous secondary battery according to claim 1, wherein in the recess-protrusion formation step, a pressurization member having a projecting portion projecting from a base portion is pressurized in contact with the laminated body to form the recess and/or the protrusion in the laminated body, and upon pressurization, only the projecting portion of the pressurization member contacts the laminated body.

3. The method for manufacturing the non-aqueous secondary battery according to claim 1, further comprising: before the recess-protrusion formation step, a warming step of warming the laminated body.

4. The method for manufacturing the non-aqueous secondary battery according to claim 1, wherein
the recess-protrusion formation step and the pressurization flattening step are performed in such a manner that the laminated body passes between rollers, and
a diameter of each roller used in the pressurization flattening step is greater than a diameter of each roller used in the recess-protrusion formation step.

5. A device for manufacturing a non-aqueous secondary battery, comprising:
a laminator that laminates a positive electrode layer containing a positive electrode active material and an electrolyte layer containing a solid electrolyte to obtain a laminated body;
a recess-protrusion former that forms a recess and/or a protrusion extending from one side to the other side in a planar direction of the laminated body while applying pressure to the laminated body in a thickness direction thereof from the one side to the other side; and
a pressurization flattener that flattens the recess and/or the protrusion while applying pressure to the laminated body in the thickness direction thereof.

6. The device for manufacturing the non-aqueous secondary battery according to claim 5, wherein
each of the recess-protrusion former and the pressurization flattener has rollers that sandwich the laminated body while the laminated body passes therebetween, and
a diameter of each roller of the pressurization flattener is greater than a diameter of each roller of the recess-protrusion former.
